(19) United States
(12) Patent Application Publication
(10) Pub. No.: US 2004/0021572 A1
(43) Pub. Date: Feb. 5, 2004

(54) Electronic baggage tracking and identification

(76) Inventors: Marc L. Schoen, Redmond, WA (US); Kosal Svy, Covington, WA (US); Stephen L.M. Hockaday, Port Hadlock, WA (US)

Correspondence Address: HARNESS, DICKEY & PIERCE, P.L.C., P.O. BOX 828, BLOOMFIELD HILLS, MI, 48303, US

(21) Appl. No.: 10/212,650

(22) Filed: Aug. 5, 2002

(51) Int. Cl. G08B 13/14

(52) U.S. Cl. 340/572.1

(57) ABSTRACT

An aircraft baggage system includes a baggage container adapted for aircraft stowage. The baggage container has a set of security components including an electronic tagging device electrically connected with an encoded lock, a liner unit, a magnetic switch and an antenna. The electronic tagging device generates container status signals which indicate if an unauthorized opening of the baggage container has occurred. The electronic tagging device can transmit and receive signals between the baggage container and a remote interrogation system. A query signal from the remote interrogation system is received by the container antenna. The query signal queries the electronic tagging device for a container status signal. The electronic tagging device generates the container status signal for transmission by the container antenna. The container status signal also identifies the baggage container location. The baggage container is provided in predetermined sizes to maximize aircraft stowage.

### FIELD OF THE INVENTION

The present invention relates to temporary storage devices and more particularly to electronically identifiable baggage containers for stowage on a mobile platform.

### BACKGROUND OF THE INVENTION

Air travel security is a major item of interest to airlines as well as passengers using the airlines. Passenger baggage which is loaded or carried onto an aircraft can potentially be opened and explosives or other devices added which are dangerous to the safety of aircraft travelers and the airlines. Passenger baggage now comes in a multitude of shapes and sizes which renders the baggage difficult to search and difficult to stow onboard aircraft.

Passenger baggage is currently inspected primarily using manual methods of inspection and also using some additional non-intrusive methods including X-ray detection. The non-intrusive methods require additional manual labor and inspection in order to accomplish. The manual method of baggage inspection is both time consuming and expensive, and may not be effective in identifying all types of devices which may be located within a particular bag or piece of baggage. The baggage is available for contamination (i.e., opening) between the inspection process and placement onboard aircraft or other modes of transport.

The system now used to enter and withdraw baggage from airline check-in and check-out facilities also has several drawbacks. Currently, passengers can check their bags either at curb side areas adjacent to airline terminals or at the airline ticket counter in the terminal building. Most baggage is not inspected at this time, but is merely marked with an identification tag for later claim by the passenger. From the check-in points, the check-in baggage is manually loaded into a transport system which transports the bags or baggage into a temporary holding facility prior to their being sorted and stowed onboard the particular aircraft for the passenger's flight. Manual or non-intrusive inspection of the bags can be conducted at this time, however, absolute security is not maintained at all stages of the baggage handling procedure. Baggage can be opened and have additional contents added at any step during this phase, and one bag can be substituted for another. There is also no immediate way to determine whether the person or parties who checked in the bag or piece of baggage have actually boarded the aircraft which the baggage has been loaded onto. Baggage transferred from one flight to another is often not reinspected and therefore becomes another opportunity for the baggage to be opened or substituted by unauthorized personnel.

A need therefore exists for a standardized baggage set which provides identification between the traveler and the baggage, a security system which the airlines can use to identify that the passenger or person who has checked in each piece of baggage has boarded the aircraft, and a security system which allows identification of whether an individual piece of baggage has been opened with or without proper authorization or if the bag itself has been externally penetrated. A similar need also exists for the same identification between the traveler and baggage carried by the passenger onto the aircraft.

### SUMMARY OF THE INVENTION

According to a preferred embodiment of the present invention, an identifiable secured baggage (ISB) provides for security monitoring of the ISB using an identification tagging device which includes the ability to locate, monitor, track, and correlate baggage from its initial check point to a final destination. The ISB is provided in one of several standard sizes to improve the loading density of cargo/baggage storage on aircraft. Each ISB includes an integrated electronic identification tag and security system components designed to report information about the individual piece of baggage, as well as any possible security violation or penetration of the bag, when interrogated by a wireless strategically located interrogation system known in the art.

The ISB includes six major components. The standard baggage unit (SBU) is the container selected from one of the standard envelope sizes. A baggage liner unit (BLU) is provided for each SBU which in a preferred embodiment is formed as a flexible material containing loops of conductive wires lined throughout an outer perimeter of each SBU. An encoded lock unit (ELU) is a mechanical combination lock that additionally provides an encoder built-in allowing a difference between an authorized and an unauthorized opening of the SBU to be identified. The ELU can be either a combined encoder with a mechanical lock or the encoder can be separate from the mechanical lock. A magnetic switch unit (MSU) is provided to detect the opening and closing of the standard baggage. An electronic tag unit (ETU) is provided to collect and report all of the pertinent information about the SBU when interrogated. An antenna unit (AU) is also provided for each standard baggage unit which is constructed of low cost conductive loops or spirals embedded in one or more of the surfaces of the standard baggage. The antenna unit is provided to transmit or receive information about the individual baggage to or from a remote interrogator unit.

The electronic tag unit (ETU) includes a radio frequency (RF) section which further includes a receiver, a transmitter, and a transceiver switch. The ETU is also provided with a micro-controller, a non-volatile memory module, and a battery to provide backup power for the ETU. When an RF signal is received by the antenna unit of the SBU, power from the interrogator signal is used to “wake up” the ETU to provide a response. The ETU then transmits back to the interrogator the status of the SBU, including if the SBU has been opened, if the opening was authorized, the location of the SBU relative to a monitoring position, and a security status identifying if the SBU has been penetrated.

The SBU is in wireless communication with an interrogator to send and receive signals to and from the SBU unit. The interrogator is known in the art and operates at a low frequency, ranging from about 1 MHz to about 1 GHz. A plurality of interrogators can be located about an aircraft terminal, onboard each individual aircraft, at both baggage drop off and recovery location areas which can be remote from aircraft terminals, and in the baggage sorting system in outbound baggage. Each interrogator unit has an operating range extending from approximately 1 yard to approximately 150 yards depending on the frequency selected and line-of-sight interferences between the interrogator unit and the SBU.

The ETU uses pulse coded modulation signals to communicate with the interrogator. The receiver incorporates a circuit to decode and capture the incoming RF signal from the interrogator through the antenna unit. The ETU thereby obtains commands as well as power for the ETU and the ISB. The transmitter module is a low power RF oscillator, which is modulated with the information requested by the interrogator. A memory module contains all information relating to the status of the baggage, including an identification code, a user lock combination code, and a security status code. A simple low cost micro-controller is used to monitor, decode, and manage all of the statuses, activities, and responses associated with the ISB.

In a preferred embodiment, the ISB has either a clock mechanism or a sequential numbering device to either monitor a time at each opening of the ISB or to monitor with a sequential number each opening of the ISB. This permits any opening of an ISB to be continuously traced once the ISB enters the security system of the airline.

Further areas of applicability of the present invention will become apparent from the detailed description provided hereinafter. It should be understood that the detailed description and specific examples, while indicating the preferred embodiment(s) of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram representing an identifiable secured baggage in accordance with a preferred embodiment of the present invention, in electrical communication with an interrogator and a computer used to collect and correlate the data from the identifiable secured baggage;

FIG. 2 is a block diagram of an identifiable secured baggage in accordance with a preferred embodiment of the present invention showing the six major component parts of the identifiable secured baggage;

FIG. 3 is a block diagram of the component parts of the electronic tag unit of the present invention;

FIG. 4 is a block diagram identifying a typical operation of an identifiable secured baggage of the present invention if a device penetrates through the baggage liner unit of the present invention;

FIG. 5 is a block diagram identifying the interrelationship between the magnetic switch unit, the encoded lock unit, and the electronic tag unit of the present invention;

FIG. 6 is a perspective view showing a cargo/baggage stowage container or carry-on stowage known in the art loaded with a plurality of identifiable secured baggage units of the present invention;

FIG. 7A is a block diagram representing an identifiable secured baggage in accordance with a preferred embodiment of the present invention, showing a clock mechanism to trace openings of the identifiable secured baggage;

FIG. 7B is a block diagram representing an identifiable secured baggage in accordance with FIG. 7A, further showing a subsequent time change signifying a later opening of the identifiable secured baggage;

FIG. 8A is a block diagram representing an identifiable secured baggage in accordance with a preferred embodiment of the present invention, showing a sequential numbering device to trace openings of the identifiable secured baggage; and

FIG. 8B is a block diagram representing an identifiable secured baggage in accordance with FIG. 8A, further showing a sequential number change signifying a later opening of the identifiable secured baggage.

### DETAILED DESCRIPTION OF THE PREFERRED EMBODIMENTS

The following description of the preferred embodiments is merely exemplary in nature and is in no way intended to limit the invention, its application, or uses.

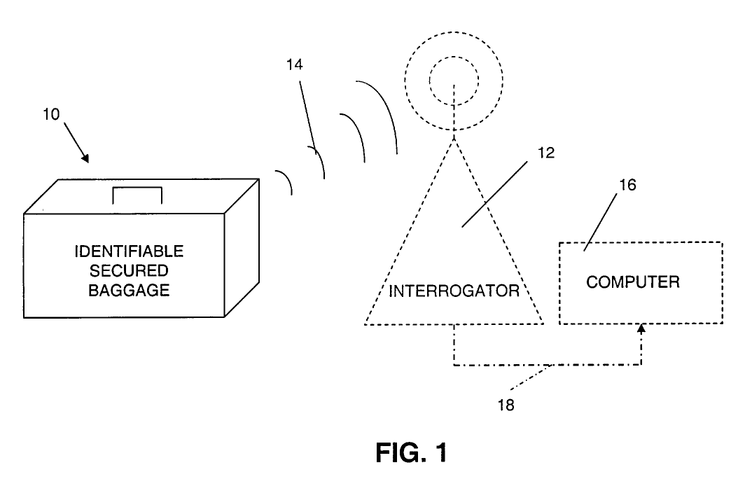

Referring to FIG. 1, an identifiable secured baggage (ISB) 10 of a preferred embodiment of the present invention is shown in its relationship with an interrogator unit 12. The ISB 10 forms a container or baggage unit for transporting clothing, equipment, and personal belongings. The ISB 10 can be located in a distance ranging from about 1 yard (0.9 m) to about 150 yards (135 m) from an interrogator unit 12. The ISB 10 is in electrical communication with the interrogator 12 via a plurality of RF signals 14. The interrogator 12 is shown in communication with a computer 16 via a data transmission path 18. The interrogator 12 together with the computer 16 are known in the art. The interrogator 12 generally comprises an RF generator having an antenna for transmission of signals to the ISB 10. The computer 16 stores data relative to the ISB 10 and a plurality of additional ISB units (not shown). The computer 16 can be located at an airline terminal, on a vehicle, or at any suitable remote location chosen.

Each one of a plurality of interrogator units 12 is positionable in a variety of locations throughout an airline terminal, onboard individual aircraft, and in locations where baggage is either checked in, sorted, or retrieved. Each interrogator unit 12 has its own identifier such that if the ISB 10 is within the distance range of the interrogator unit 12 the approximate location of the ISB 10 will be known.

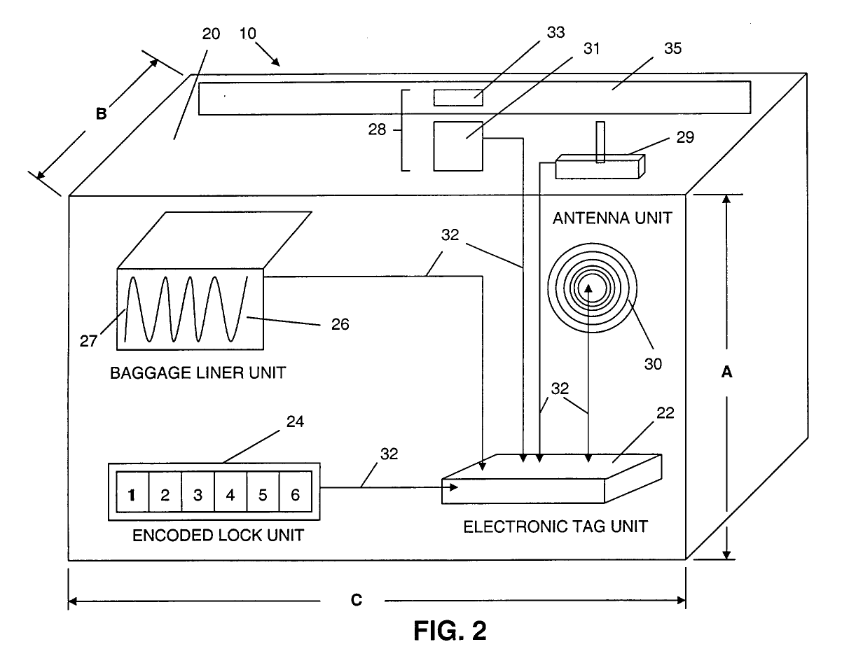

Referring now to FIG. 2, the major components of an identifiable secured baggage 10 of the present invention are shown. Each ISB 10 has an ISB height A, an ISB depth B, and an ISB width C. The height, depth and width of the ISB 10 are chosen from a preselected quantity of ISB 10 unit sizes.

Each ISB 10 comprises a body 20 formed of a nonmetallic material. A nonmetallic material is selected for the body 20 such that non-intrusive inspection known in the art, including X-ray inspection of the ISB unit 10 can be used and the contents of an ISB 10 can be displayed thereon. The material for an ISB 10 is preferably selected from composite or plastic materials such that a rigid form of the ISB 10 is retained when baggage or personal items are stowed within.

Each ISB unit 10 also comprises an electronic tag unit (ETU) 22, an encoded lock unit (ELU) 24, a baggage liner unit (BLU) 26, a magnetic switch unit (MSU) 28, and an antenna unit 30. The ETU 22 collects data from each of the items listed and stores the information in a memory unit which will be discussed further herein. The ETU 22 is normally in a “sleep mode”. In the sleep mode, the ETU 22 uses minimal amounts of power and can be awakened from the sleep mode by a signal received querying the ISB 10 for data of its status. The ETU 22 will be further described below.

The ELU 24 is a mechanical combination lock or separate encoding device that has an encoded combination number built in allowing the ETU 22 to identify and distinguish between an authorized and an unauthorized opening of the ISB 10. Combination numbers for the ELU 24 are preferably preselected such that each ISB 10 has a unique combination number acting as its coded identification number. In a preferred embodiment, the ELU 24 produces a digital signal representing digital code for each of the code numbers used in its designation. The quantity of combination numbers required for the ELU 24 is variable, and the six-digit display shown in FIG. 2 is exemplary of one of many possibilities. In an alternate embodiment the combination number and the coded identification number for each ISB 10 is selected by a user from a large digit quantity (i.e., 8 or more numbers) such that duplication of any two ISB 10 coded identification numbers is mathematically improbable. If an authorized combination (i.e., coded identification) number is entered into the ELU 24 a signal is transferred via a data line 32 to the ETU 22. Similarly, if an unauthorized combination number is used in an attempt to open the ISB 10, a similar signal is transferred along the data line 32 to the ETU 22.

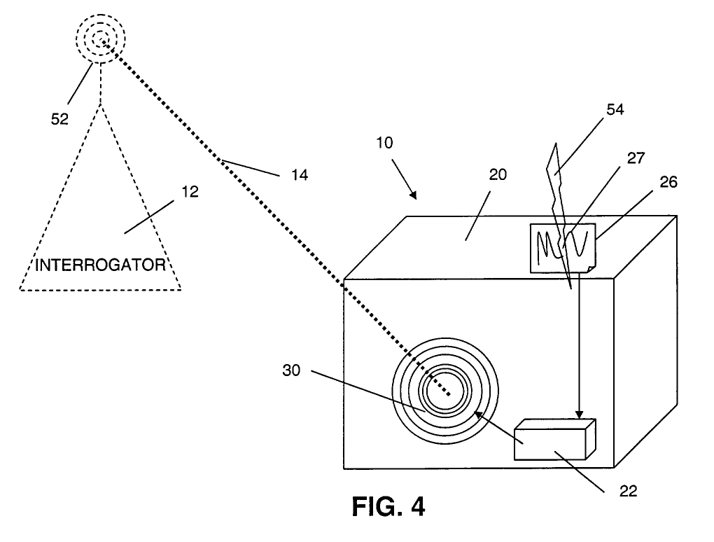

The BLU 26 comprises a thin, flexible material containing loops of conductive wires designed to detect penetration into the ISB 10. The BLU 26 is positioned adjacent to an outer surface of the body 20 of the ISB 10. The entire perimeter of the ISB 10 is therefore protectively covered by the BLU 26, with the exception of the sections of the ISB 10 which are opened for loading or unloading of material. A small voltage is transferred between the ETU 22 and the BLU 26 such that an impedance of the coils 27 is continuously monitored. If an object (shown in FIG. 4) penetrates the outer layer of the body 20, the coils 27 are broken and the loop impedance is changed. A change in the loop impedance is sensed by the ETU 22 and a signal is generated indicating that the body 20 of the ISB 10 has been penetrated.

The BLU 26 is formed of a metallic mesh in a preferred embodiment of the present invention. The BLU 26 is preferably formed in individual sections, each attached to a surface of the ISB 10. Power to measure the impedance of the coil 27 of the BLU 26 is generated entirely by the ETU 22. Operating power for the ISB 10 is conserved by positioning an ISB switch 29 in an off position when the user is not using the ISB 10. When the ISB switch 29 is in the off position power is not supplied to the BLU 26 for impedance measurement. At the option of the designer, the ISB switch 29 can be one of a manual or an automatic switch type such that in manual mode an on or off position of the switch is manually selected, and in an automatic type switch the ISB 10 will power down automatically after a predetermined time period.

The MSU 28 is a simple magnetic switch having generally a two-part construction. A first part 31 of the MSU 28 is connectably affixed to the body 20 of the ISB 10. A second part 33 of the MSU 28 is fixedly attached to a hinged or opening member 35 of the body 20 whereby the contents of the body 20 are accessed. When the ISB 10 is in a closed position, the first part 31 and the second part 33 of the MSU 28 are in contact with each other and a signal is generated along the data line 32 indicating that the ISB 10 is closed. If an authorized code is entered into the ELU 24 and the ISB 10 is opened, the second part 33 of the MSU 28 disengages from the first part 31 and a signal is generated along the data line 32 to the ETU 22 indicating that the ISB 10 is in an open position.

If the opening member 35 of the body 20 is opened when an unauthorized code has been entered into the ELU 24, or if the opening member 35 is forcibly opened, the lack of an authorized code in the ELU 24 together with the indication via the MSU 28 of an ISB 10 open position will signal the ETU 22 that an unauthorized opening of the ISB 10 has occurred.

The antenna unit 30 is constructed of conductive loops or spirals of wire embedded in an outer surface of the body 20 of the ISB 10. The antenna unit 30 can also be embedded within the BLU 26. The status of the ISB 10 is transmitted through the antenna unit 30 or a query signal from an interrogator 12 (shown in FIG. 1) is either transmitted or received by the antenna unit 30. Between the antenna unit 30 and the ETU 22, signals are transferred via one of the plurality of data lines 32.

The ISB switch 29 is preferably configured such that the ISB switch 29 is automatically positioned to an off position when an authorized code is entered into the ELU 24. Similarly, the ISB switch 29 is preferably configured such that the ISB switch 29 is always in an on position when the ISB 10 is closed, unless the user manually selects an off position when the ISB 10 is not in use. Other switch types known in the art can also be used for the ISB switch 29, including pressure switches which react to baggage content weight and automatic switches which shut off power after a predetermined time interval of nonuse.

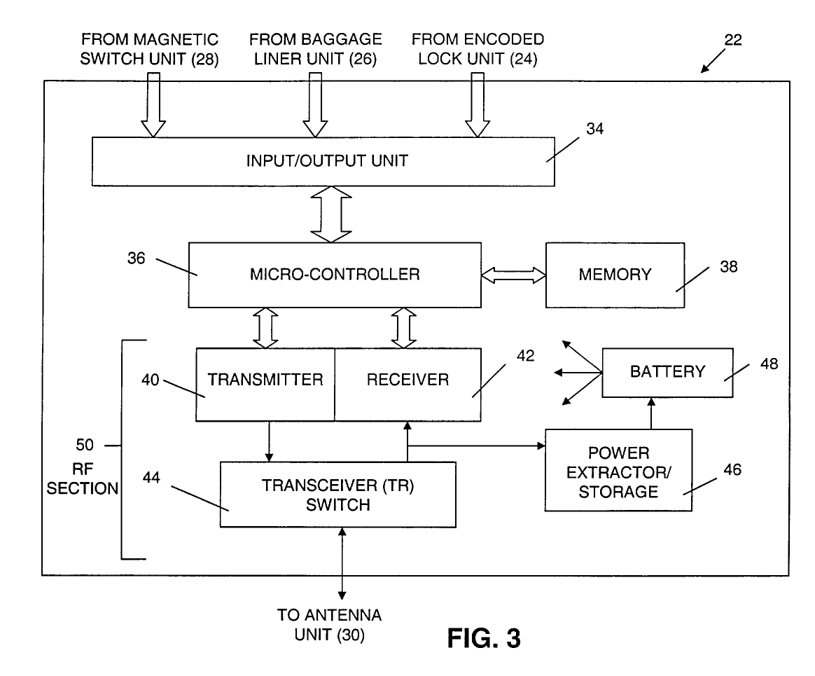

Referring now to FIG. 3, the details of the ETU 22 are further shown. An input/output unit 34 receives signals from each of the MSU 28, the BLU 26, and the ELU 24. Signals from the input/output unit 34 are transferred to a micro-controller 36. The micro-controller 36 is preferably an electronic processor based on a circuit board that also includes a memory unit 38. The micro-controller 36 accesses data in the memory unit 38 to generate a signal in response to a query from the interrogator 12 (shown in FIG. 1). The micro-controller 36 is in communication with both a transmitter 40 and a receiver 42. Both the transmitter 40 and the receiver 42 are in communication with a transceiver switch 44. The transceiver switch 44 is normally aligned in a receive position to relay signals coming in from the interrogator 12 through the antenna unit 30. In order to minimize the number of antennas required by an ISB 10, the transceiver switch 44 permits switching between the receive position and a transmit position for the single antenna unit 30.

A battery 48 is connectably disposed to provide power to the ETU 22 and also to provide power for the impedance test through the coils 27 of the BLU 26 (shown in FIG. 2). The battery 48 is preferably of a lithium design, however other battery designs can be substituted. A power extractor/storage unit 46 is provided between the receiver 42 and the transceiver switch 44. The power extractor/storage unit 46 acts as a capacitor to recharge the battery 48 from a portion of the RF signal 14 received by the antenna unit 30. The power extractor/storage unit 46 also temporarily stores power and for a short term can power the ETU 22 if the battery 48 is discharged.

The transmitter 40, the receiver 42, and the transceiver switch 44 are positioned in an RF section 50 of the ETU 22. RF signals generated by the ETU 22 are transmitted by the transmitter 40 through the transceiver switch 44 to the antenna unit 30.

Referring now to FIG. 4, the ISB 10 is shown transmitting a response signal to the interrogator 12 via an interrogator antenna 52, indicating a penetration of the BLU 26. If the BLU 26 is penetrated by any device, for example an intrusion device 54 as shown, at least one of the coils 27 of the BLU 26 is broken which changes the overall impedance of the coils 27. When the impedance of the coils 27 changes, the signal forwarded to the ETU 22 is modified. When queried by the interrogator 12, the ISB 10 transmits the modified signal as the RF signal 14 which is interpreted by the computer 16 (shown in FIG. 1) as a penetration of the BLU 26.

Referring back to FIG. 2, in an ISB 10 authorized open condition (i.e., an authorized code is entered into the ELU 24 and the first part 31 of the MSU 28 is separated from the second part 33), the ELU 24 electronically produces an authorized container open signal which is forwarded to the ETU 22. In a container unauthorized open condition (i.e., an unauthorized code is entered into the ELU 24 and the first part 31 of the MSU 28 is separated from the second part 33), the ELU 24 electronically produces an unauthorized container open signal which is forwarded to the ETU 22. In a container closed condition (i.e., the first part 31 and the second part 33 of the MSU 28 are in physical contact), the ELU 24 electronically produces a container closed signal which is forwarded to the ETU 22.

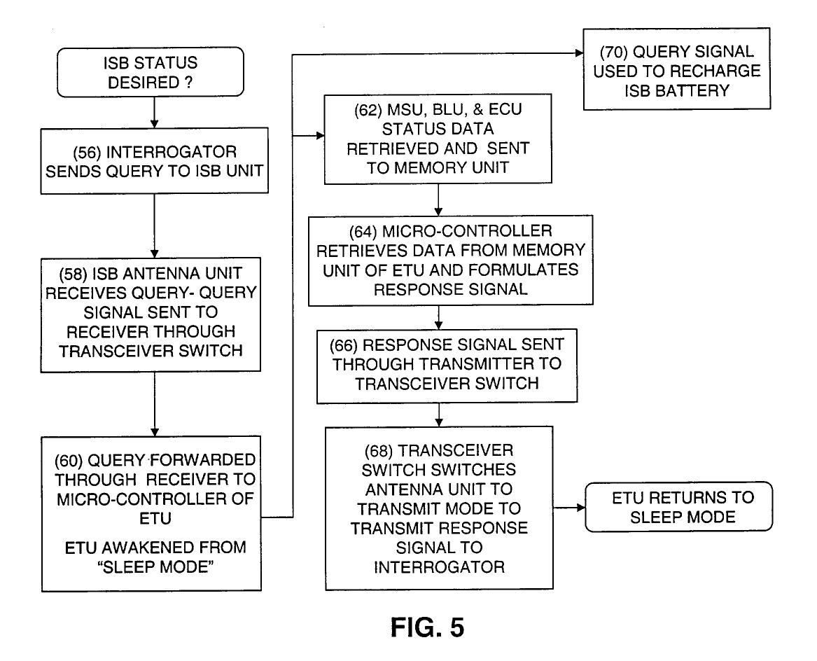

Referring to FIG. 5, the general steps required to query an ISB 10 are shown. If the ISB status is desired, in a query step 56 the interrogator sends a query signal to the ISB unit. In a receiving step 58, the ISB antenna unit receives the query signal from the interrogator and the query signal is automatically sent to the receiver through the transceiver switch of the ETU. The transceiver switch is normally positioned in the receive mode. In a forwarding step 60, the query is forwarded from the receiver to the microcontroller of the ETU. Upon receipt of this query signal, the ETU is awakened from its “sleep mode”. In a retrieving step 62, the MSU, the BLU, and the ECU status data are retrieved and sent to the memory unit. In a formulation step 64, the micro-controller retrieves the data from the memory unit of the ETU and formulates a response signal to the query signal. In a sending step 66, the response signal is sent through the transmitter to the transceiver switch. In a switching step 68, the transceiver switch switches the antenna unit to the transmit mode to transmit the response signal back to the interrogator. FIG. 5 also identifies in a charging step 70 that a portion of the query signal is used to recharge the ISB battery. Following the switching step 68 where the signal response is sent back to the interrogator, the ETU returns to the sleep mode which reduces the power consumption of the ISB.

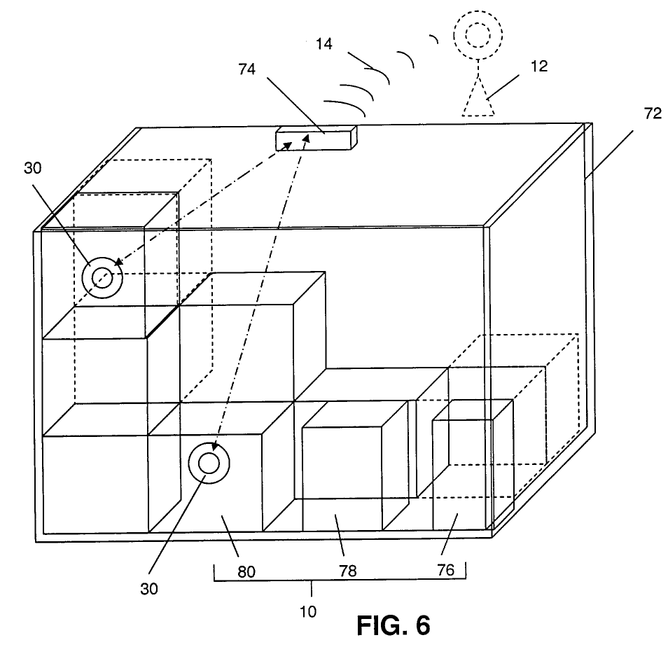

Referring now to FIG. 6, the stacking concept using the multiple sizes of the ISB units of the present invention is shown. A modularized cargo/baggage stowage container 72 is shown. The modularized cargo/baggage stowage container 72 is known in the art, and is generally provided in universal sizes used by a plurality of airlines. By preselecting the envelope size of each ISB, maximum use of the volume of the modularized cargo/baggage stowage container 72 is possible. A selection of three space envelopes is used including a small container 76 having a first container geometry, a medium container 78 having a second container geometry and a large container 80 having a third container geometry. The small container 76 envelope and the medium container 78 envelope are preselected such that an incremental quantity of small containers 76 and of medium containers 78 together have an envelope equaling a large container 80 envelope.

Each modularized cargo/baggage stowage container 72 is also provided with a signal repeater 74 which is known in the art. The material of the modularized cargo/baggage stowage container 72 is typically comprised of metal, plastic, or laminate for a majority of the perimeter of the container. Metal reduces the signal strength of RF signals to each ISB 10 in the modularized cargo/baggage stowage container 72. To assist in retrieving data from any of the particular ISB units stowed in a modularized cargo/baggage stowage container 72, the signal repeater 74 is used. The RF signal received from the interrogator is relayed to each of the ISB units stowed in the modularized cargo/baggage stowage container 72 via each of their respective antenna units. A status of any ISB stowed in the modularized cargo/baggage stowage container 72 can therefore be ascertained by aircraft personnel.

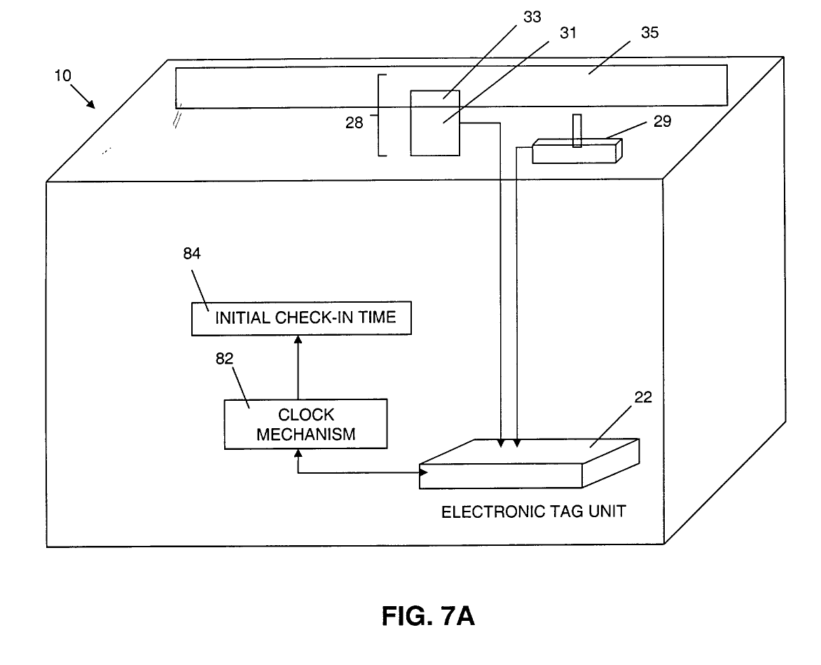

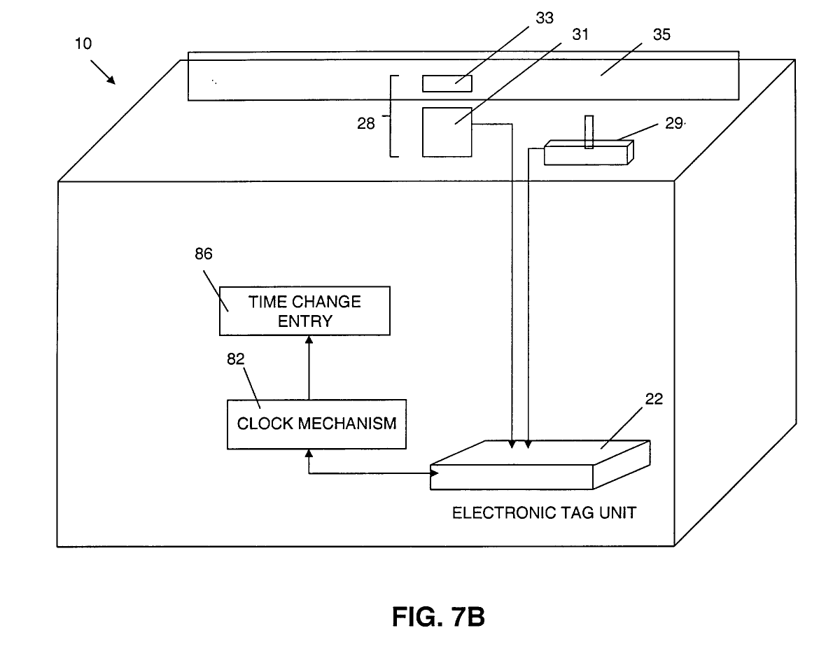

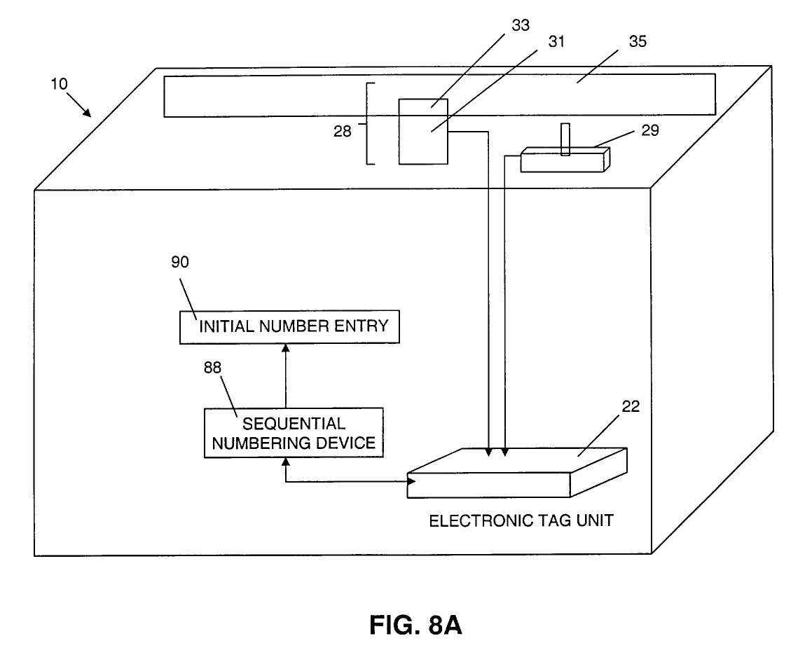

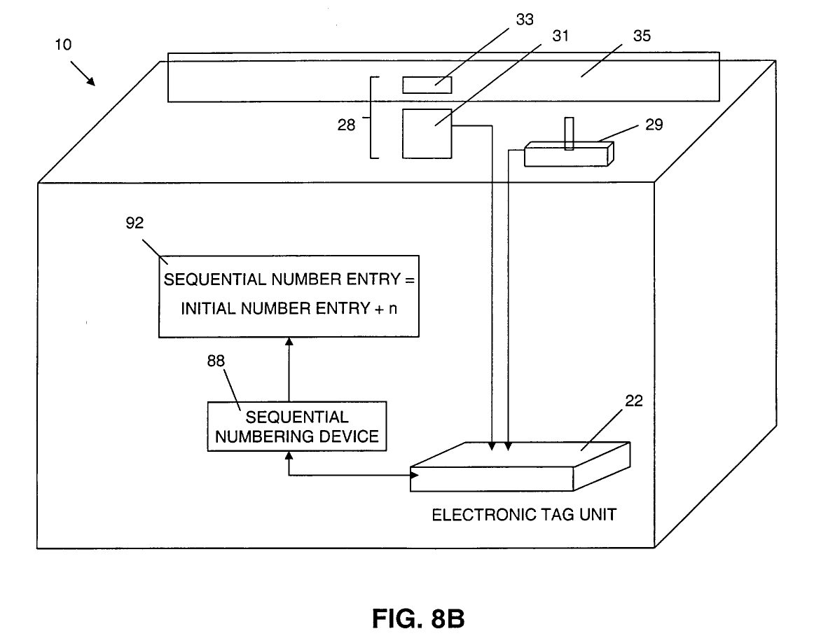

Referring now to FIGS. 7A and 7B, and 8A and 8B, in another preferred embodiment of the ISB 10, each opening of the ISB 10 is traceable. In a first exemplary traceable opening shown in FIGS. 7A and 7B, a clock mechanism 82 is included with the circuitry of the ETU 22. In FIG. 7A, the clock mechanism 82 is part of the circuitry of the ELU 22 but for clarity is shown separate from the ELU 22. The ISB 10 is closed, as indicated by a contact position between the first part 31 and the second part 33 of the MSU 28. An initial check-in time 84 is generated and saved when the ISB 10 is initialized into the airline system or initally passes through a security inspection (i.e., X-ray inspection of carry on baggage required to enter the gate area of an airport).

As shown in FIG. 7B, an opening of the opening member 35 has occurred indicated by a non-contact position between the first part 31 and the second part 33 of the MSU 28. The opening after the initial check-in time 84 (shown in FIG. 7A) triggers a time change entry 86 by the clock mechanism 82 into the ETU 22. The time change entry 86 is transmitted by the ETU 10 in response to a query of the unit status. The time change entry 86 being different from the initial check-in time 84 identifies the ISB 10 has been opened since a last query or security check. The clock mechanism 82 can trace any opening of the ISB 10 from the time the ISB switch 29 is positioned to the “on” position. The clock mechanism 82 can read out actual time in hours, minutes, and seconds or can read out a relative time starting when the ISB switch 29 is switched to the on position.

In a second exemplary traceable opening shown in FIGS. 8A and 8B, a sequential numbering device 88 is included with the circuitry of the ETU 22. In FIG. 8A, an initial number entry 90 is logged in by the sequential numbering device 88 when the ISB 10 is initialized into the airline system or initally passes through a security inspection (i.e., X-ray inspection of carry on baggage required to enter the gate area of an airport). The ISB 10 remains closed during the initialization or is closed before the initial number entry 90 is made. A closed status is indicated by a contact position between the first part 31 and the second part 33 of the MSU 28.

In FIG. 8B, a subsequent opening of the opening member 35 has occurred indicated by a non-contact position between the first part 31 and the second part 33 of the MSU 28. This subsequent opening triggers a sequential number entry 92 (sequential number entry 92 equal to initial number entry 90+n) into the ETU 22. The sequential number entry 92 is transmitted by the ISB 10 in response to a query of the unit status. The sequential number entry 92 is comparable to the initial sequential number entry 90 to determine if the ISB 10 has been opened since the security inspection and a determination can then be made if an additional security inspection is required (i.e., in order to board the aircraft). Any number generated as the sequential number entry 92 indicates the ISB 10 has been opened, i.e., “n” added to the initial number entry 90 where “n” normally equals a value of one. The initial number entry 90 and the sequential number entry 92 preferably range from approximately 0 to 99, however, any range of numbers are selectable. The initial number entry 90 preferably does not reset to zero when the ISB switch 29 is set to the off position to prevent an ISB 10 opening to go unrecognized.

The ETU 22 has approximate dimensions of about 5.2 cm (2 in) wide by about 5.1 cm (2 in) deep and about 1.3 cm (0.5 in) thick. In a preferred embodiment, the ETU is positioned within a surface of the ISB or secured in a corner of the ISB such that it cannot be damaged by items placed into the ISB. Access is also provided in the ISB for recharging or replacement of the battery 48.

The RF signals for an identifiable secured baggage of the present invention will range from about 1 MHz to about 1 GHz. The interrogator interrogates the plurality of identifiable secured baggage of the present invention at a frequency ranging from approximately once per second to approximately once per micro-second. Each interrogator signal is encoded such that random signals reaching the identifiable secured baggage will not trigger a response and unauthorized users cannot access the system. Encoding of RF signals is well known in the art and will therefore not be discussed in greater detail herein.

The ISB of the present invention is capable of being located remote from a plurality of carrier locations including: an airport, a train station, a bus station, a ship's pier; or remote from a plurality of individual carrier units including: an aircraft, a train, a bus, a ship, a taxi, or a car. The remote location capability therefore provides for electronic, remote check-in and tracking of each ISB with an Internet based system known in the art using the digitally encoded combination number as a unique identifier of each ISB.

The identifiable secured baggage of the present invention offers several advantages. The ISB provides the capability to correlate an individual piece of baggage to an individual traveler. The ISB provides the capability to identify that: the baggage has not been opened, the baggage has been opened by an authorized user, the baggage has been opened by an unauthorized user, or that the baggage either has or has not been inappropriately opened such as by piercing any of the surfaces of the ISB. Each opening of an ISB is traceable using either a time of last opening or a sequential opening number to permit carry on bags to be queried even after initial security check in. Each ISB is traceable onboard an aircraft, and can therefore be correlated to a boarded passenger on the aircraft. An approximate location of each bag within an airline system is also identifiable using the ISB of the present invention. The components used to construct an ISB of the present invention are simple and lightweight.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An electronically identifiable stowage container adapted for stowage on a mobile platform comprising:
a container having one of a predetermined quantity of space envelopes and a security monitoring system;
said security monitoring system including an electronic tagging device adapted to generate at least one of a container status and a container location;
said electronic tagging device being adapted to communicate with a plurality of container security components to generate said container status; and
said container being capable of operation in each of a passive mode and an active mode, wherein in said passive mode said container status is updateable for storage in a memory unit, and wherein in said active mode said container status is retrievable from said memory unit and convertible to a transmission signal, said transmission signal being transmittable by said container.

2. The stowage container of claim 1, further comprising:
said container status including each of a container authorized open condition, a container unauthorized open condition and a container closed condition; and
each of said container authorized open condition, said container unauthorized open condition, said container closed condition and said container location being adaptable for transmission as each of a plurality of radio frequency signals generated by said electronic tagging device; and
each of said plurality of radio frequency signals being transmittable through a container mounted antenna.

3. The stowage container of claim 1, wherein said plurality of container security devices comprises at least a container liner unit, a container encoded lock, and a container magnetic switch.

4. The stowage container of claim 3, wherein said container liner unit comprises a plurality of mesh sections, each said mesh section connectably joined to each of a plurality of container surfaces and each said mesh section having a plurality of coiled wires therein.

5. The stowage container of claim 4, further comprising said plurality of coiled wires being in one of an intact condition and a severed condition, both said intact condition and said severed condition being detectable by an impedence of said plurality of coiled wires.

6. The stowage container of claim 3, wherein said container encoded lock further comprises a mechanical combination lock having one of a digital encoder and an analog encoder, said mechanical combination lock being in electrical communication with said electronic tagging device.

7. The stowage container of claim 5, further comprising:
in said container authorized open condition said container encoded lock electronically producing an authorized container open signal distinguishable by said electronic tagging device;
in said container unauthorized open condition said container encoded lock electronically producing an unauthorized container open signal distinguishable by said electronic tagging device; and
in said container closed condition said container encoded lock electronically producing a container closed signal distinguishable by said electronic tagging device.

8. The stowage container of claim 7, further comprising in said container closed condition said container closed signal being relayed to said electronic tagging device through said container magnetic switch in a coupled magnetic switch position.

9. The stowage container of claim 7, further comprising a battery connectable to said electronic tagging device, said battery usable to at least partially power said electronic tagging device.

10. The stowage container of claim 7, wherein in said container unauthorized open condition said container unauthorized open signal being generated by at least one of a de-coupled magnetic switch position and an unauthorized access code.

11. An aircraft baggage system comprising:
a baggage container adapted for stowage on an aircraft;
said baggage container having a set of security components including an electronic tagging device being in electronic communication with each of a container encoded lock, a container liner unit, a container magnetic switch and a container antenna;
said electronic tagging device being adaptable for generating a plurality of container status signals;
said electronic tagging device being further adaptable to both transmit and receive each of said plurality of container status signals between said baggage container and a remote interrogation system;
wherein said remote interrogation system transmits a query signal, said query signal being receivable by said container antenna to query said electronic tagging device for at least one of said plurality of container status signals.

12. The system of claim 11, further comprising:
said electronic tagging device including a memory module for storing a data set from each of said container encoded lock, said container liner unit, and said container magnetic switch;
said memory module being connectable to a micro-controller;
said micro-controller being operable to generate at least one of said container status signals from said data set stored in said memory module; and
a radio frequency (RF) section, said RF section including a receiver, a transmitter and a transceiver switch to selectably switch between said receiver and said transmitter.

13. The system of claim 12, wherein said electronic tagging device is powered by both a battery mounted in said container and said query signal from said remote interrogation device.

14. The system of claim 13, wherein said electronic tagging device is operatable over a frequency ranging between approximately 1 MHz to approximately 1 GHz.

15. The system of claim 13, wherein said set of security components further includes a container operation switch, said container operation switch being operable between one of a container energized position and a container de-energized position.

16. The system of claim 11, further comprising said baggage container being formable in each of a plurality of space envelopes.

17. The system of claim 14, wherein said plurality of space envelopes comprises a small container having a first container geometry, a medium container having a second container geometry and a large container having a third container geometry.

18. The system of claim 12, further comprising said first, said second, and said third container geometries being each adapted to maximize a stowable volume of a modular aircraft cargo/baggage stowage unit.

19. The system of claim 11, comprising:
a clock mechanism in communication with said electronic tag unit; and
said clock mechanism retrievably generating a check-in time of said baggage container;
wherein said check-in time of said baggage container is initialized when said baggage container is closed and said container magnetic switch is in a closed position.

20. The system of claim 19, comprising:
said clock mechanism retrievably generating a time change entry subsequent to said check-in time; and
said time change entry being generated when said container magnetic switch changes from said closed position to an open position;
wherein any difference between said check-in time and said time change entry is indicative of a status change of said baggage container.

21. The system of claim 11, comprising:
a sequential numbering device in communication with said electronic tag unit; and
said sequential numbering device retrievably generating an initial number entry;
wherein said initial number entry is initialized when said baggage container is closed and said container magnetic switch is in a closed position.

22. The system of claim 21, comprising:
said sequential numbering device retrievably generating a sequential number entry subsequent to said check-in time; and
said sequential number entry being generated when said container magnetic switch changes from said closed position to an open position;
wherein any difference between said initial number entry and said sequential number entry is indicative of a status change of said baggage container.

23. The system of claim 22, wherein said initial number entry and said sequential number entry each range from approximately zero to approximately 99.

24. A method to adapt baggage for self generation of a wireless security status signal comprising the steps of:
forming a baggage container having a plurality of perimeter walls including at least one displaceable wall;
attaching one of a plurality of wire mesh liners in each of said perimeter walls and in said at least one displaceable wall;
electrically connecting each said wire mesh liner to an electronic tagging device;
installing a power source in said baggage container for electrically powering said electronic tagging device;
routing power from said power source to said electronic tagging device to perform an impedence measurement of each said wire mesh liner; and
generating at least one signal by said electronic tagging device when said impedence measurement indicates each of an intact wire mesh condition and a severed wire mesh condition.

25. The method of claim 24, further comprising the steps of:
installing an antenna in a selected one of said perimeter walls; and
transmitting said least one signal generated by said electronic tagging device through said antenna.

26. The method of claim 25, further comprising the steps of:
installing a first section of a magnetic switch in a select one of said perimeter walls, said select one of said perimeter walls located adjacent to a select one of said at least one displaceable wall;
fixing a second section of a magnetic switch in said select one of said at least one displaceable wall in physical contact with said first section in a displaceable wall closed position;
electrically connecting said first section and said second section of said magnetic switch to said electronic tagging device; and
generating said at least one signal by said electronic tagging device when said magnetic switch is in one of a switch closed position having said first section in physical contact with said second section of said magnetic switch, and a switch open position having said first section spatially separated from said second section of said magnetic switch.

27. The method of claim 25, further comprising the steps of:
installing an encoded lock on said baggage container;
electrically connecting said encoded lock to said electronic tagging device; and
generating said at least one signal by said electronic tagging device when said encoded lock is in one of an authorized open condition, an unauthorized open condition and a closed condition.

28. The method of claim 27, further comprising the step of recharging said power source using a portion of an inquiry signal received by said antenna.

29. The method of claim 28, further comprising the step of locating said baggage container using said at least one signal.

30. The method of claim 29, further comprising the steps of;
mounting a switch on said baggage container;
electrically connecting said switch to said electronic tagging device; and
switching said electronic tagging device between one of an on position and an off position using said switch.

31. The method of claim 30, further comprising the step of switching said electronic tagging device to said off position in one of an automatic mode having a predetermined time interval and a manual mode.
